(19) United States
(12) Patent Application Publication
(10) Pub. No.: US 2015/0147113 A1
(43) Pub. Date: May 28, 2015

(54) FRAMELESS FURNITURE SYSTEM

(71) Applicant: Phillip C. Crabtree, II, Owensboro, KY (US)

(72) Inventor: Phillip C. Crabtree, II, Owensboro, KY (US)

(21) Appl. No.: 14/554,638

(22) Filed: Nov. 26, 2014

Related U.S. Application Data
(60) Provisional application No. 61/908,973, filed on Nov. 26, 2013.

(51) Int. Cl. F16B 12/10; F16B 12/44

(52) U.S. Cl. CPC F16B 12/10; F16B 12/44
USPC 403/292

(57) ABSTRACT

An article of furniture having a first furniture element connectable to a second furniture element. The first furniture element has a key that includes a groove portion adjacent a tab that extend above a surface of the first furniture element. The second furniture element defines a key hole wherein the key hole defines a groove slot portion configured to receive the groove portion of the key and a tab slot portion configured to press against the tab of the key to retain the first furniture element with the second furniture element. The tab slot portion includes a dowel seat sized to receive the tab of the key in a final assembled form of the first and the second furniture elements. Optionally the tab slot portion includes an end portion for receipt of dust and debris in the key hole.

### CROSS-REFERENCE TO RELATED APPLICATIONS

This application claims the benefit of U.S. Provisional Patent Application No. 61/908,973 filed Nov. 26, 2013, which is hereby incorporated by reference.

### BACKGROUND

The present invention relates to a frameless furniture item and a method for assembling the frameless furniture item.

Furniture components that are assembled to form furniture typically have predrilled holes and a variety of loose fasteners, such as screws, bolts, nuts, and the like, for assembling the furniture components together to form a piece of furniture. Many examples of items of furniture that are assembled in this manner include tables, chairs, benches, bookcases, desks, dressers, chests, sofas, closet systems, cabinets, and other types of furniture.

For example, a typical frameless cabinet is assembled from multiple panels having predrilled holes and a variety of loose fasteners, such as screws, bolts, nuts, ready to assemble (RTA) fasteners, camlocks, and the like, used for assembling the panels together to form the cabinet. Many frameless cabinets are sold in a flat stack configuration to an individual or consumer who then assembles the cabinets in their home or business. To assemble the cabinets, tools such as screwdrivers, hammers, and drills are required but difficult to use with the provided fasteners as the panels usually provide little clearance for the tools. Moreover, many of the predrilled holes require additional drilling by the consumer to receive the fasteners. Typically, consumers spend considerable time trying to assemble these cabinets. Then, once these cabinets are assembled, portions of the fasteners are visible on the panels thus distracting from the overall appearance of the cabinet.

Thus, there is a need for improvement in this field.

### SUMMARY

One embodiment of the present invention concerns a cabinet system having a top panel, a bottom panel, two side panels, a back panel, and two back stretcher panels positioned behind the back panel. Each of the back stretcher panels is assembled with the two side panels and one of the top or bottom panels. Each of the top panel, bottom panel, two side panels, back panel, and two back stretcher panels has an interior face and an exterior face. When the cabinet system is fully assembled, the exterior and interior faces of all of the panels are smooth without any hardware or fasteners visible on the exterior or interior surfaces. This smooth appearance is visually pleasing to the consumer.

Another embodiment of the present invention concerns a cabinet system having a top panel, a bottom panel, two side panels, a back panel, and two back stretcher panels. Each of the side panels includes a plurality of key holes positioned along a top edge and a bottom edge. Moreover, each of the side panels includes a plurality of extended key holes along a back edge. Each of the top panel, bottom panel, and back stretcher panels includes a plurality of keys along each of their respective side edges for engagement with the key holes and extended key holes of the side panels to attach the top panel, bottom panel, and back stretcher panels to the side panels without additional fasteners or glue. If desired, glue or another adhesive can be added to the key holes and the extended key holes for assembly with the keys. Beneficially, the keys are attached to the top panel, bottom panel, and back stretcher panels; therefore a consumer does not require additional tools to assemble the cabinet system. Moreover, when the cabinet system is fully assembled, none of the keys, key holes, or extended key holes is visible on any of the panels.

Another embodiment of the present invention includes the unique shape and dimensions of the key hole and extended key hole and the interaction of the keys with the key hole and extended key hole to assemble two furniture elements. For example, some of the furniture elements that include the keys, key holes, and extended key holes for assembly include the various elements that are used to form tables, chairs, sofas, bookshelves, desks, dressers, vanities, frames, beds, and the accessories such as knobs, pulls, hardware, hinges, that can be attached to the furniture elements. A first furniture element includes one or more key holes and/or extended key holes and a second furniture element includes a corresponding number of keys wherein a single key is inserted into either a single key hole or extended key hole. The key has an exposed tab and an exposed groove portion that is inserted into either the key hole or the extended key hole. Other embodiments can include different shapes for the key. The extended key hole is very similar to the key hole except the extended key hole includes a tab guideway portion that begins at a back edge of the side panel or furniture item and forms an angle with the back edge. The tab guideway portion of the extended key hole extends to a tab opening in the side panel or furniture item. The key hole or extended key hole includes a tab opening that tapers from a larger diameter to a smaller diameter wherein the larger diameter facilitates insertion of the tab into the tab opening. The tab opening has a depth that corresponds to the combined depth or thickness of the exposed tab and the exposed groove portion of the key. Adjacent the tab opening, the key hole includes a tab slot portion that is sized to receive the exposed tab and a groove slot portion that is sized to receive the exposed groove portion. The tab slot portion has a width that corresponds to the diameter of the tab. The tab slot portion also includes a ramp, a dowel seat, and an end portion wherein each of these parts provides additional benefits to the connection between the keys and the key holes or the extended key holes. The taper of the ramp from the tab opening towards the dowel seat causes a force to be applied to the tab during assembly of the cabinet system. In essence, the tab is squeezed by the ramp as it moves towards the dowel seat. Next, as the tab enters or passes into the dowel seat, the user will feel a tactile sensation as the tab snaps into the dowel seat. The dowel seat has a groove that is curved with a radius that matches the radius of the exposed tab. Moreover, the dowel seat provides a tight connection or joint between the panels or furniture items. Another benefit of the dowel seat is that as the tab snaps into the dowel seat, the stress on the groove portion of the key caused by the taper of the ramp on the tab is reduced. The end portion is sized to receive dust or debris that may be retained in the key hole due to manufacture of the key hole or extended key hole in the side panels or furniture items. The groove slot portion has a smaller width than the tab slot portion such that the key cannot be pulled out of the key hole when the top, bottom, back stretcher, side panels, or any other furniture items are assembled.

Yet another unique embodiment of the present invention includes the assembly of the frameless furniture item or cabinet system. Beneficially, no additional hardware or fasteners, such as loose screws, nails, bolts, etc., or tools, such as screwdrivers, hammers, drills, etc., are required to assemble the frameless furniture item or cabinet system. Instead, keys are mounted on the edges of the top, bottom, and back stretcher panels, and key holes and extended key holes in the side panels enable quick and easy assembly of the frameless furniture item or cabinet system. Moreover, after the panels are assembled to form the frameless furniture item or cabinet system, none of the keys, key holes, or extended key holes is visible thus creating a pleasing appearance.

One technique of assembling one embodiment of the frameless furniture item or cabinet system includes positioning one of the side panels on a substantially flat surface such as the floor or a table. Next, the top and bottom panels are each assembled with the single side panel. It does not matter which of the top or bottom panels is assembled first with the side panel. To assemble either the top or bottom panel with the side panel, the extended tabs and groove portions of the keys on the top or bottom panel are inserted into the tab openings of the key holes of the side panel. Next, the top or bottom panel is pushed across the side panel towards the slot such that the tabs ride along the tab slot portions and the groove portions ride along the groove slot portions. More specifically, the tabs are pushed along the tab slot portion such that the angle of the ramp causes a force to be applied to the tab. In essence, the tabs are squeezed by the ramps as the tabs move toward the dowel seats, but the tabs generally do not enter the dowel seats. At this position, the ramp applies a force to the tab to maintain the alignment of the top and bottom panels with the side panel.

Next the back panel is inserted into the slot of the side panel and the channels of the top and bottom panels. Next the other side panel is aligned with the top and bottom panels such that the extended tabs and groove slot portions of the keys on the top and bottom panels enter the tab openings of the key holes on the other side panel.

The partially assembled frameless furniture item including the top panel, bottom panel, side panels, and back panel is rotated such that the back panel is facing down and closest to the flat surface, such as the floor (but not resting directly thereon). Then the top and bottom panels are tapped or pressed into alignment with the side panels. During this alignment step, the tabs enter or pass into the dowel seats, and the user will feel a tactile sensation as the tabs snap into the dowel seats and the grooves. Next the partially assembled frameless furniture item is rotated such that the back panel is facing up. Each of the back stretcher panels is assembled with the side panels and the respective top or bottom panel by inserting the tabs and groove portions on the back stretcher panels into the starting end of the tab guideway portion of extended key holes and sliding the tabs along the tab guideway portion to the tab opening. As the tab enters the tab opening, the tab and groove portion are pushed along the ramp to the dowel seat. When the back stretcher panel is fully assembled with the top panel, an edge portion of the back stretcher panel will fit into the channel of the top panel. Likewise, when the second back stretcher panel is fully assembled with the bottom panel, the edge portion of the back stretcher panel will fit into the channel of the bottom panel.

Other examples of furniture items that utilize keys and key holes or extended keyholes to connect various elements of a furniture item include tables, benches, chairs, cabinets, closet systems, bookcases, futons, sofas, dressers, and chests of drawers, to name a few. These furniture items can include two side panels and one or more of top, bottom, or rear elements or panels attached to the side panels with keys and key holes or extended key holes. For example, a bench system includes two side panels and one or more panels that span between the side panels wherein the one or more panels are connected to the side panels by the interaction of keys and key holes or extended key holes. Additionally, these furniture items can include any type of furniture part, such as a leg, shelf, side, top, bottom, panel, cushion, hinge, knob, fastener, and other types of hardware that are attached to the furniture part. The furniture items are assembled similarly as above wherein a first furniture element having a key and a second furniture element having a key hole are to be assembled. The extended tab and groove slot portion of the key on the first furniture element is inserted into the tab opening of the key hole of the second furniture element. Next, the first furniture element is pushed across the second furniture element towards the slot such that the tab rides along the tab slot portion and the groove portion rides along the groove slot portion. More specifically, the tab is pushed along the tab slot portion such that the angle of the ramp causes a force to be applied to the tab. In essence, the tab is squeezed by the ramp as the tab moves toward the dowel seat. At this position, the ramp applies a force to the tab. After the tab enters the dowel seat, the force on the tab is reduced and the first and second furniture elements are fully assembled. When the first and second furniture elements are fully assembled, enough force remains on the tab to ensure a tight fit between the first and second furniture elements.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a front perspective view of a frameless cabinet system according to one embodiment of the present invention.

FIG. 2 is a front view of an interior face of a top panel and an interior face of a bottom panel of the cabinet system illustrated in FIG. 1.

FIG. 3 is a side view of the top panel illustrated in FIG. 2.

FIG. 4 is a front view of an interior face of two side panels of the cabinet system illustrated in FIG. 1.

FIG. 5 is a front view of an interior face of a back panel of the cabinet system illustrated in FIG. 1.

FIG. 6 is a front view of an interior face of each of two back stretcher panels of the cabinet system illustrated in FIG. 1.

FIG. 7 is a side view of one embodiment of a key of the cabinet system illustrated in FIG. 1.

FIG. 8 is a cross-sectional view of a key hole in the side panel illustrated in FIG. 4.

FIG. 9 is a partial cross-sectional view of an extended key hole in the side panel illustrated in FIG. 4.

FIG. 10 is a partial cross-sectional view of the extended key hole in the side panel illustrated in FIG. 4.

FIG. 11 is an end view of the back stretcher panel illustrated in FIG. 6.

FIG. 12 is a partial side view of the key hole illustrated in FIG. 8.

FIG. 13 is a partial side view of the key hole illustrated in FIG. 10.

FIG. 14 is a front perspective view of a bench system according to a second embodiment of the present invention.

FIG. 15 is a side view of an interior face of a first side panel of the bench system illustrated in FIG. 14.

FIG. 16 is a side view of an interior face of a second side panel of the bench system illustrated in FIG. 14.

FIG. 17 is a side view of an exterior face of an optional third side panel illustrated in FIG. 14.

FIG. 18 is a side view of an exterior face of an optional fourth side panel illustrated in FIG. 14.

FIG. 19 is a front view of a first back panel of the bench system illustrated in FIG. 14.

FIG. 20 is a front view of a second back panel of the bench system illustrated in FIG. 14.

FIG. 21 is a front view of a seat panel of the bench system illustrated in FIG. 14.

FIG. 22 is a front view of a first seat support panel of the bench system illustrated in FIG. 14.

FIG. 23 is a front view of a second seat support panel of the bench system illustrated in FIG. 14.

FIG. 24 is a front view of a third back panel of the bench system illustrated in FIG. 14.

FIG. 25 is a front view of a frameless closest system according to another embodiment of the present invention.

FIG. 26 is a front view of an interior face of a side panel of the closet system illustrated in FIG. 25.

FIG. 27 is a front view of a horizontal panel of the closet system illustrated in FIG. 25.

FIG. 28 is a front perspective view of a second embodiment of a key of the present invention.

FIG. 29 is a front view of the key as illustrated in FIG. 28.

FIG. 30 is an enlarged left end view of the key as illustrated in FIG. 28.

FIG. 31 is a perspective view of another embodiment of a joint of the present invention.

FIG. 32 is a perspective view of the joint assembled from FIG. 31.

FIG. 33 is a front view of a front element of another embodiment of an article of furniture of the present invention.

FIG. 34 is a front view of a first side element of another embodiment of an article of furniture of the present invention.

FIG. 35 is a front view of a second side element of another embodiment of an article of furniture of the present invention.

FIG. 36 is a front view of a back element of another embodiment of an article of furniture of the present invention.

FIG. 37 is a front view of a bottom element of another embodiment of an article of furniture of the present invention.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The present invention generally concerns a unique furniture system and method of assembling furniture components to form an article of furniture. Some examples of articles of furniture that can be assembled include tables, chairs, benches, bookcases, desks, dressers, chests, sofas, closet systems, cabinets, and other types of furniture, as well as hardware, fasteners, and other decorative elements to the articles of furniture. Typically these articles of furniture include two side components and a plurality of furniture components such as top, middle, and bottom components wherein each of the top, middle, and bottom components attach to and span between the two side components. Each of the top, middle, and/or bottom components includes a plurality of keys or dowels along a pair of side edges of each of these components. Each specific type of article of furniture may require a different arrangement and number of top, middle, and/or bottom components that span between the side components. For example, a first article of furniture may require a top and one or more middle components but no bottom component. As another example, a second article of furniture may require one or more middle components and a bottom component but no top component. Each of the two side components includes a plurality of key holes along each side face. The key holes are sized and spaced to receive and retain the keys to connect the top, middle, and/or bottom components with the two side components. The number and placement or location of the key holes aligns with the number and placement of keys when the side components are assembled with the top, middle, and/or bottom components, respectively. Other embodiments include a different arrangement of keys and key holes. For example, in another embodiment, a bench system includes two side panels having a plurality of key holes and one or more panels having a plurality of keys wherein the panels span between the two side panels when the keys are inserted in the key holes. As another example, in one embodiment, a closest system includes one side panel having a plurality of key holes along both side faces to enable attachment of at least one horizontal panel to each face such that the horizontal panels are attached to both faces of the single side panel. As such, the horizontal panels can function as shelves in the closet system. Moreover, a different number of horizontal panels can be positioned between pairs of side panels. Yet other embodiments include two furniture elements wherein a first furniture element includes a key and the second furniture element includes a key hole for receipt of the key to thereby connect the first furniture element to the second furniture element.

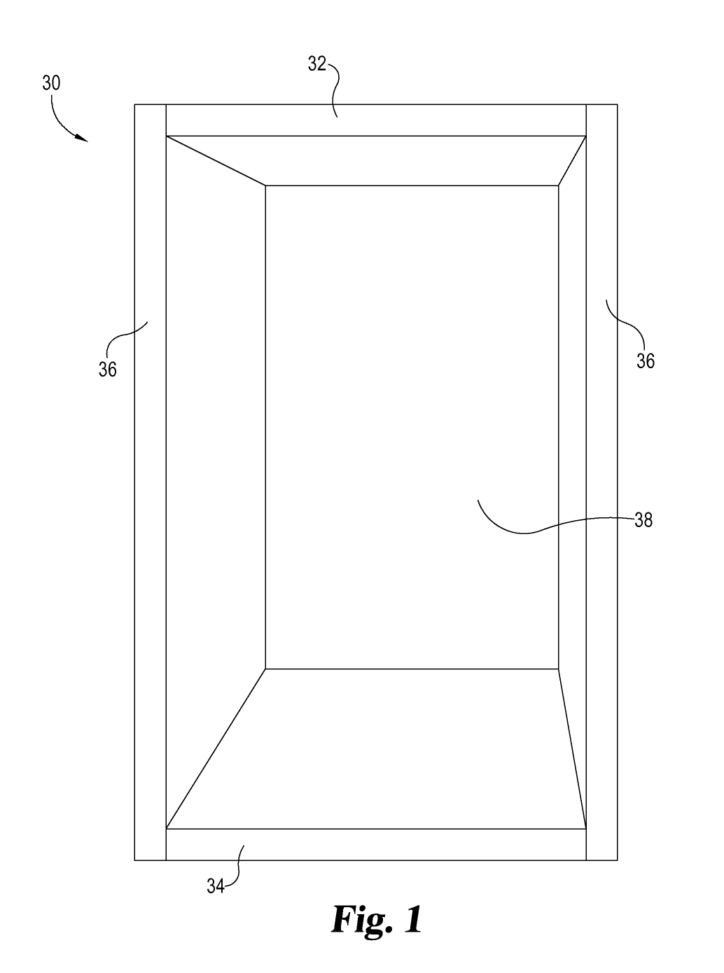

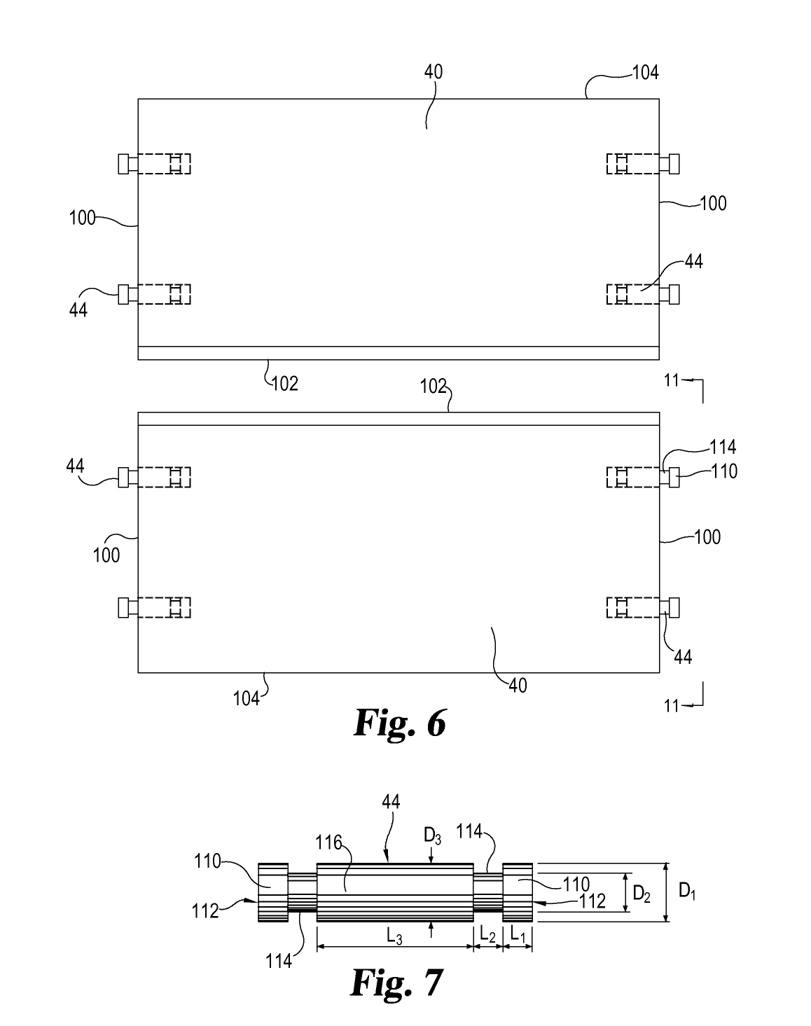

One embodiment of the present invention includes a cabinet system 30 as shown in FIG. 1. The cabinet system 30 includes a top panel 32, a bottom panel 34, two side panels 36, a back panel 38, and two back stretcher panels 40 (illustrated in FIG. 6). The back stretcher panels 40 are positioned behind the back panel 38 when the cabinet system 30 is assembled; therefore the back stretcher panels 40 are hidden in FIG. 1. In other embodiments, one or more middle shelves, drawers, racks, hardware, and/or bars for hanging clothing articles, shoes, hats, and the like, are attached to any of the top panel 32, the bottom panel 34, and the side panels 36. In yet other embodiments, some but not all of the top panel, bottom panel, back panel, and back stretcher panels may be included to form the cabinet system 30.

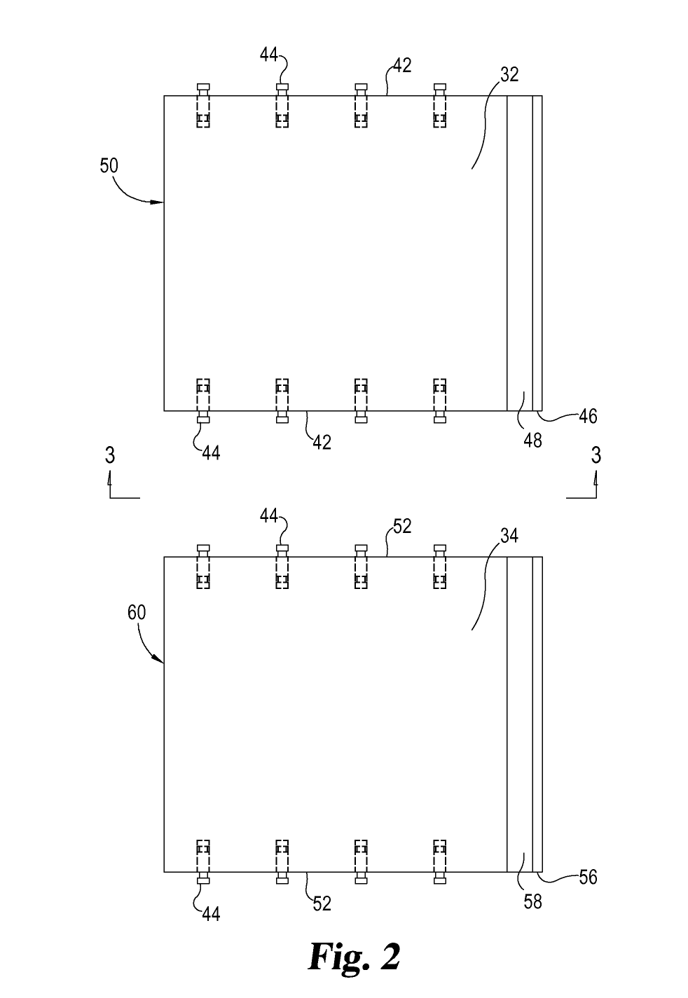

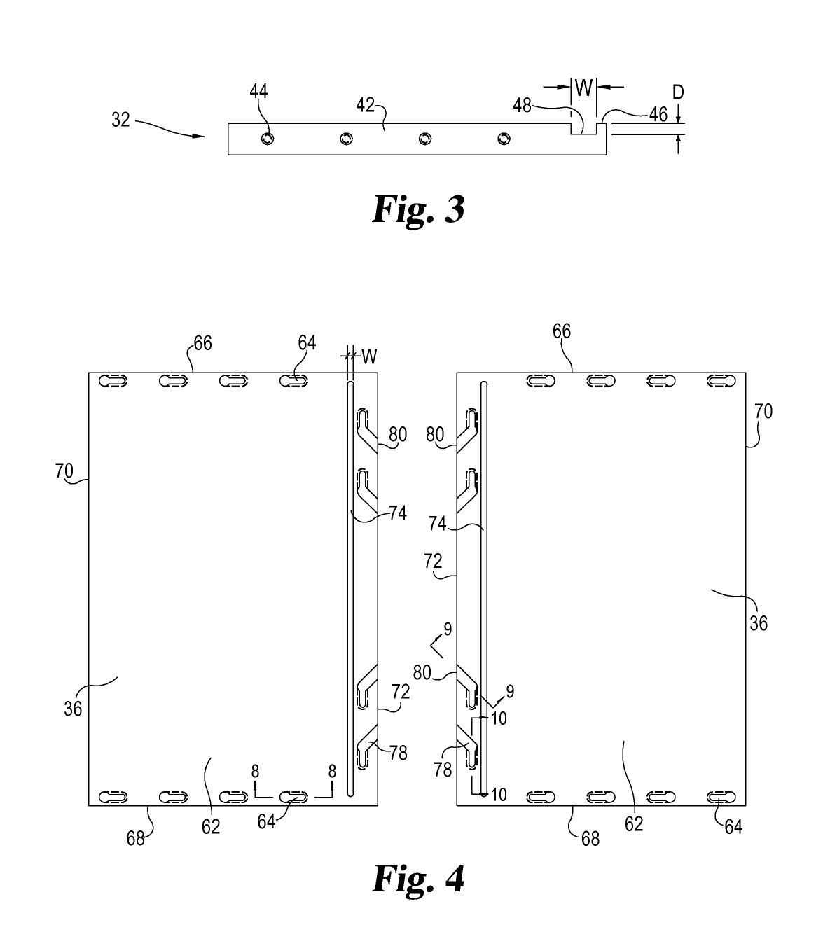

As shown in FIGS. 2 and 3, the top panel 32 includes a pair of side edges 42. Along each of the side edges 42 is a plurality of keys or dowels 44. In the illustrated embodiment, there are four keys 44 spaced equidistant from one another along each of the side edges 42; however, other embodiments can include more or less keys 44 or a different spacing between each of the keys 44. The top panel 32 also includes a side portion 46 adjacent a channel 48 wherein both the side portion 46 and channel 48 span the width of the top panel 32 between the pair of side edges 42. The channel 48 has a U-shape with a width, W, that corresponds to the combined thickness of the back panel 38 and an edge portion 108 of the back stretcher panel 40 (described more below). The top panel 32 also includes a front edge 50 opposite the side portion 46 that spans the width of the top panel 32 between the pair of side edges 42. In this embodiment, the front edge 50 is a smooth surface without holes or fasteners such that when the cabinet system 30 is assembled, the user sees an aesthetically pleasing finish to the cabinet system 30.

The bottom panel 34 is also shown in FIG. 2 and is very similar to the top panel 32. In the illustrated embodiment, the top panel 32 is interchangeable for the bottom panel 34. The bottom panel 34 includes a pair of side edges 52. Along each of the side edges 52 is a plurality of keys or dowels 44. In this embodiment, there are four keys 44 spaced equidistant from one another along each of the side edges 52; however, other embodiments can include a different number of keys 44 or a different spacing between each of the keys 44. The bottom panel 34 further includes a side portion 56 adjacent a channel 58 that spans the width of the bottom panel 34 between the pair of side edges 52. Channel 58 is similar to or the same size and shape as channel 48. The bottom panel 34 also includes a bottom edge 60 opposite the side portion 56 that spans the width of the bottom panel 34 between the pair of side edges 52. In the illustrated embodiment, the bottom edge 60 is a smooth surface without holes or fasteners such that when the cabinet system 30 is assembled, the user sees an aesthetically pleasing finish to the cabinet system 30.

The side panels 36 are illustrated in FIG. 4. Each of the side panels 36 includes an interior face 62 having a plurality of key holes 64 that are positioned along a top edge 66 and a bottom edge 68. Each of the side panels 36 also includes an exterior face (not illustrated) that is opposite the interior face 62. In this embodiment, the exterior face of each of the side panels 36 is smooth. Each of the side panels 36 also has a front edge 70 opposite a back edge 72 wherein the front and back edges 70 and 72, respectively, span between the top and bottom edges 66 and 68, respectively. A first set of the key holes 64 are located along the interior face 62 close to or near the top edge 66 and a second set of the key holes 64 are located along the interior face 62 close or near the bottom edge 68. The key holes 64 are sized to receive and retain the keys 44 of the top and bottom panels 32 and 34, respectively, as described more below, to retain the top and bottom panels 32 and 34 with the side panels 36. Moreover, the number and placement or location of key holes 64 aligns with the number and placement of keys 44 when the side panels 36 are assembled with the top and bottom panels 32 and 34, respectively. Each of the key holes 64 has a depth that is less than the thickness of the side panel 36.

The interior face 62 of each of the side panels 36 also includes a slot 74 near the back edge 72. The slot 74 extends close to both the top edge 66 and the bottom edge 68 but the slot 74 does not extend completely to intersect the top and bottom edges 66 and 68. The slot 74 has a length and width that corresponds to the length and width of a side edge 90 of the back panel 38. The depth of the slot 74 is sufficient to receive and retain the side edge 90 of the back panel 38 to retain the back panel 38 with the side panel 36. Moreover, the depth of the slot 74 is less than the thickness of the side panel 36. When the back panel 38 is assembled with the side panels 36, the side edge 90 of the back panel 38 is received in one of the slots 74 of the side panels 36. The interior face 62 of the side panels 36 also includes a plurality of extended key holes 78 wherein a starting end 80 of the extended key hole 78 begins at the back edge 72 of side panel 36. Additional details of the extended key hole 78 are described below. The extended key holes 78 have a depth that is less than the thickness of the side panel 36.

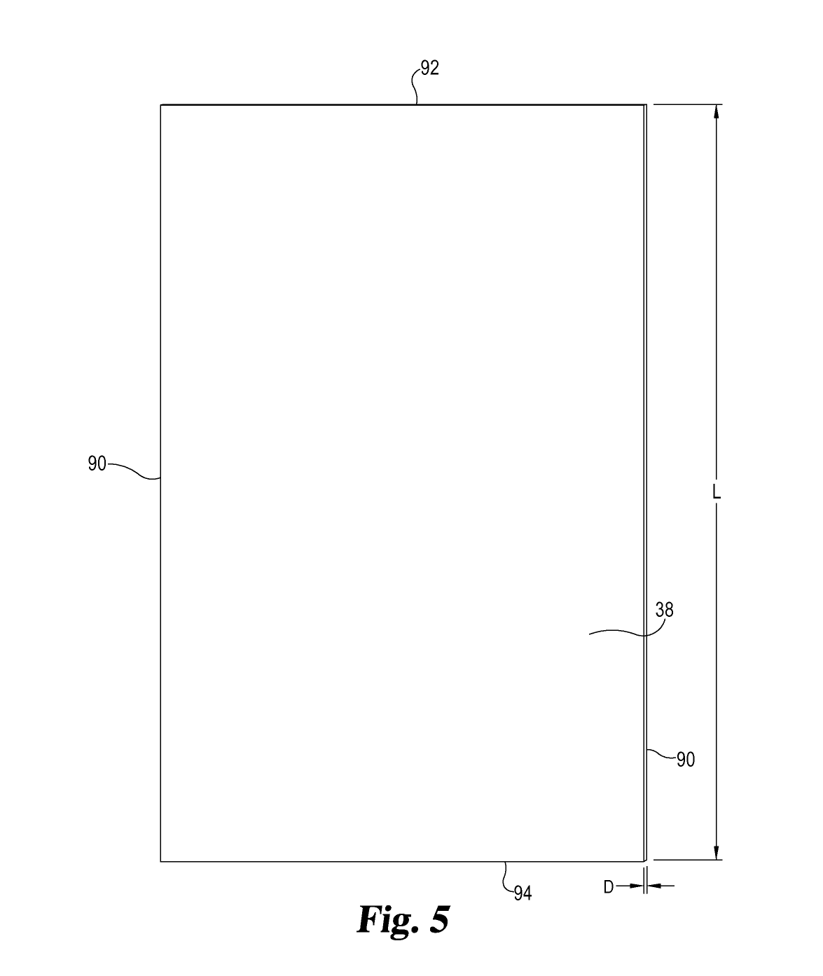

The back panel 38 is illustrated in FIG. 5. The back panel 38 includes a pair of side edges 90 that span between a top edge 92 and a bottom edge 94. The length L of the side edges 90 is similar or the same as the length of slot 74 of each of the side panels 36. The back panel 38 also includes a depth or thickness, D, that corresponds to the width, W, of the slot 74. When the back panel 38 is assembled with the side panels 36, the side edges 90 and a portion of the back panel 38 adjacent the side edges 90 fits in the slot 74 of the side panels 36. For a more pleasing appearance, the length of the slot 74 is related to the thickness of the top panel 32 and the bottom panel 34 and the location of the key holes 64 in the side panels 36. In this embodiment, the dimensions of the length of the slot 74, thickness of the top and bottom panels 32 and 34, and location of key holes 64 are chosen such that when the cabinet system 30 is assembled, the top and bottom panels 32 and 34 contact the top and bottom edges 92 and 94, respectively, to eliminate any gaps between the top and bottom panels 32 and 34, respectively, and the back panel 38.

The back stretcher panels 40 are illustrated in FIGS. 6 and 11. The back stretcher panels 40 are interchangeable for use with either the top panel 32 or the bottom panel 34 and the side panels 36. The back stretcher panels 40 have a pair of side edges 100 that span between a top edge 102 and a bottom edge 104. In the illustrated embodiment, along each of the side edges 100 are two keys 44. Other embodiments can include a different number of keys 44. In an assembled state, the length of side edge 100 of one of the back stretcher panels 40 spans about one-third to about one-half the length of the back edge 72 of the side panel 36. The number of keys 44 corresponds to the number of extended key holes 78 in the portion of the side panel 36 that engages the back stretcher panel 40. In the illustrated embodiment, there are two extended key holes 78 in the portion of the side panel 36 that receives the two keys 44 along the side edge 100 of one of the back stretcher panels 40. The keys 44 on the back stretcher panels 40 are the same as the keys 44 on the top and bottom panels 32 and 34, respectively. In other embodiments, the back stretcher panels 40 may have different shapes or sizes of keys than those keys on the top and bottom panels 32 and 34, respectively.

As illustrated in FIG. 11, along the top edge 102 is a recess 106 that spans the length of the top edge 102 of the back stretcher panel 40. The recess 106 has a width, W, that is less than or about the same as the width of either of the side portion 46 of the top panel 32 or the side portion 56 of bottom panel 34. The recess 106 also has a depth, D, that corresponds to the thickness of the side portion 46 as defined by or equivalent to the depth of the channel 48, D, of the top panel 32. The top edge 102 also includes an edge portion 108 that is determined by the total depth of the top edge 102 less the depth, D, of recess 106. When the back stretcher panels 40 and the back panel 38 are assembled with the top and bottom panels 32 and 34, the channels 48 and 58 of the top and bottom panels 32 and 34, respectively, receive the top and bottom edges 92 and 94, respectively, of the back panel 38. Additionally, the channels 48 and 58 each receive the edge portion 108 of one of the back stretcher panels 40.

During assembly of the cabinet system 30, both of the back stretcher panels 40 are assembled with the side panels 36 such that a tab 110 and a groove portion 114 of each of the keys 44 on the back stretcher panels 40 are inserted into the starting ends 80 of the extended key holes 78. Next, the back stretcher panel 40 is slid along side panel 36 such that the keys 44 slide along the extended key holes 78 to position the back stretcher panels 40 against the back panel 38 and the side panels 36 (described more below).

A key 44 is illustrated in FIG. 7 and includes a tab 110 at each end 112, a groove portion 114 next to each of the tabs 110, and an extender 116 that spans between the groove portions 114. The tab 110, the groove portion 114, and the extender 116 are each a cylindrical shape. The tab 110 has a diameter D1 and a length L1, the groove portion 114 has a diameter D2 and a length L2, and the extender 116 has a diameter D3 and a length L3. In the illustrated embodiment, the diameter D1 of the tab 110 is larger than the diameter D2 of the groove portion 114 however the lengths L1 and L3 are about the same. The diameter D3 of the extender 116 is about the same as the diameter D1 of the tab 110 however the length L3 is longer than either length L1 or length L2. In other embodiments, the diameters D1, D2, and D3 and lengths L1, L2, and L3 of the tabs 110, groove portions 114, and extender 116, respectively, can vary from one another or the illustrated embodiment. Further, in other embodiments, the key 44 can be shaped and sized differently.

When the key 44 is assembled with any of the top, bottom, or back stretcher panels 32, 34, and 40, respectively, most of the key 44 is inserted into the respective panel such that only one of the tabs 110 and the adjacent groove portion 114 extends from the panel. For example, when the top panel 32 is assembled with the side panels 36, the exposed tab 110 and adjacent groove portion 114 of the key 44 are inserted into the key hole 64 of the side panel 36 and the top panel 32 slides across the side panel 36 as the tab 110 and groove portion 114 of the key 44 rides in the key hole 64 (described more below).

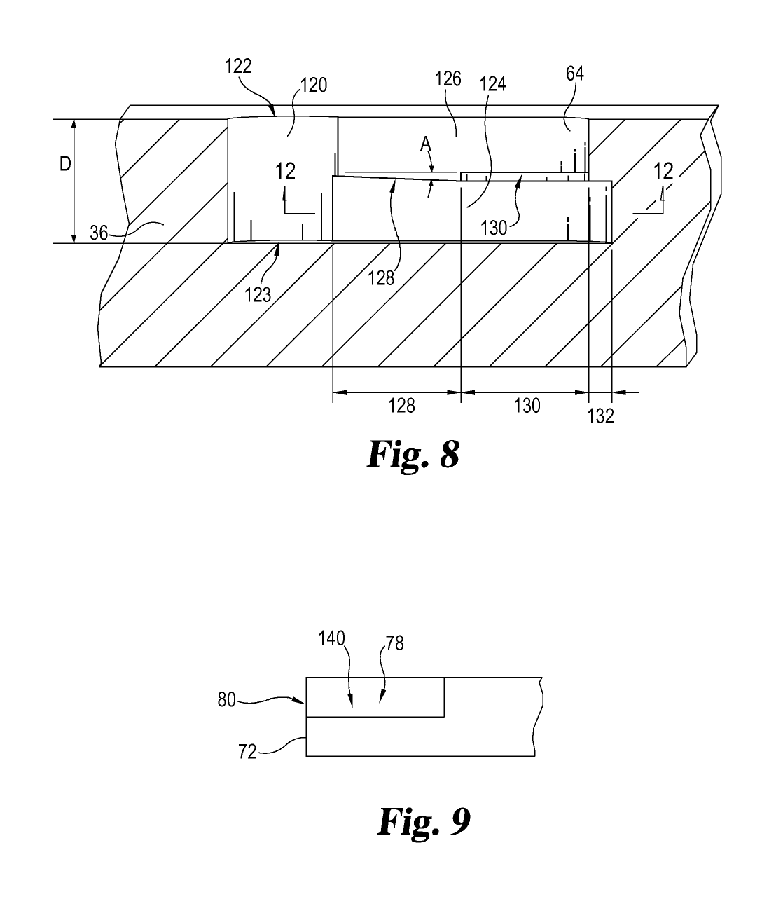

A cross-section of a key hole 64 on the side panel 36 is illustrated in FIG. 8. The key hole 64 includes a tab opening 120 that has a first diameter 122 that is slightly larger than the diameter of the tab 110 to facilitate and ease insertion of tab 110 into tab opening 120. The tab opening 120 has a second diameter 123 that is smaller than first diameter 122. The second diameter 123 is about the same size diameter as tab 110. The tab opening 120 also has a depth D that corresponds to the combined length L1 of the tab 110 and length L2 of the adjacent groove portion 114 of key 44. The key hole 64 also includes a tab slot portion 124 that is sized to receive the tab 110 and a groove slot portion 126 that is sized to receive the groove portion 114. The tab slot portion 124 has a width that corresponds to and is about the same as the diameter of tab 110. The tab slot portion 124 also includes a ramp 128, a dowel seat 130, and an end portion 132. The ramp 128 tapers in a vertical direction from the tab opening 120 towards the dowel seat 130. The taper of the ramp 128 or angle A can range from about 0.5 degrees to about 30 degrees. Moreover, the ramp 128 has a width W illustrated in FIG. 12 that retains the tab 110 in the tab slot portion 124.

During assembly of the cabinet system 30, the tab 110 is pushed along the tab slot portion 124 such that the angle A of the ramp 128 causes a force to be applied to the tab 110. In essence, the tab 110 is squeezed by the ramp 128 as it moves towards the dowel seat 130. As the tab 110 enters or passes into the dowel seat 130, the user will feel a tactile sensation as the tab 110 snaps into the dowel seat 130. The dowel seat 130 has a groove 134 that is curved with a radius that matches the radius of the tab 110. Moreover the dowel seat 130 is slightly raised or elevated from the ramp 128 which reduces the vertical force on the tab 110 but keeps the tab 110 locked in the tab slot portion 124. As such another benefit of the dowel seat 130 is that as the tab 110 snaps into the dowel seat 130, stress on the groove portion 114 caused by the taper of ramp 128 on the tab 110 is reduced. The end portion 132 is sized to receive dust or debris that may be retained in the key hole 64 when the key hole 64 was formed in the side panels 36. The groove slot portion 126 has a smaller width than the tab slot portion 124 such that the key 44 cannot be pulled out of the key hole 64 when the top, bottom, and side panels 32, 34, and 36 are assembled.

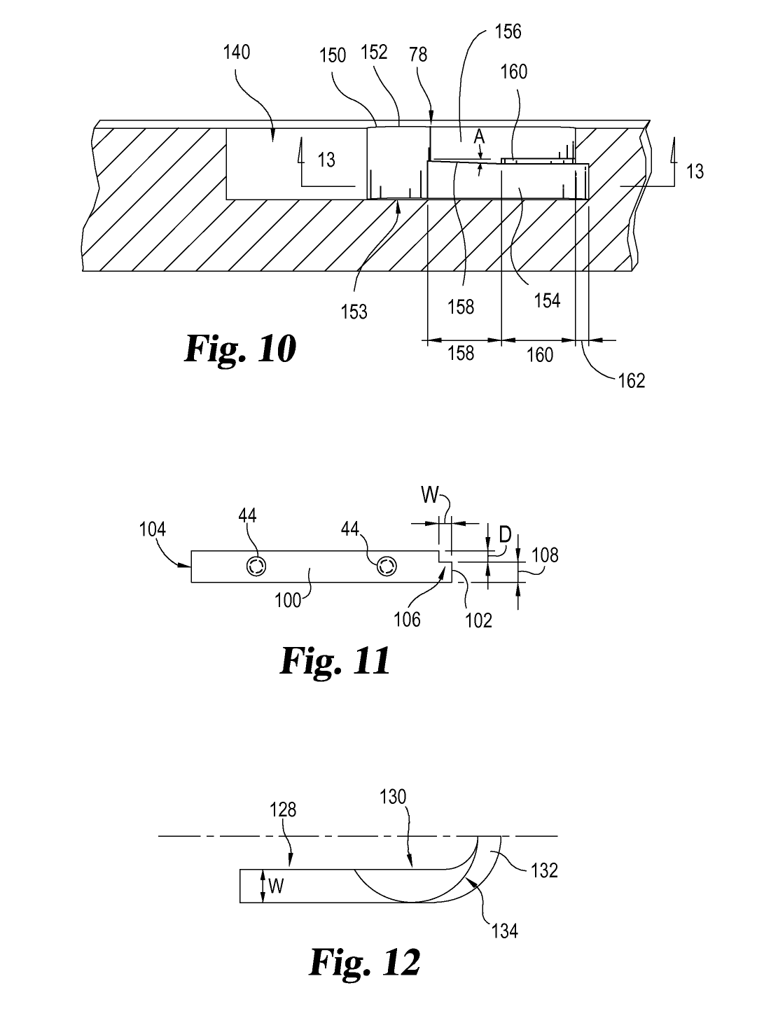

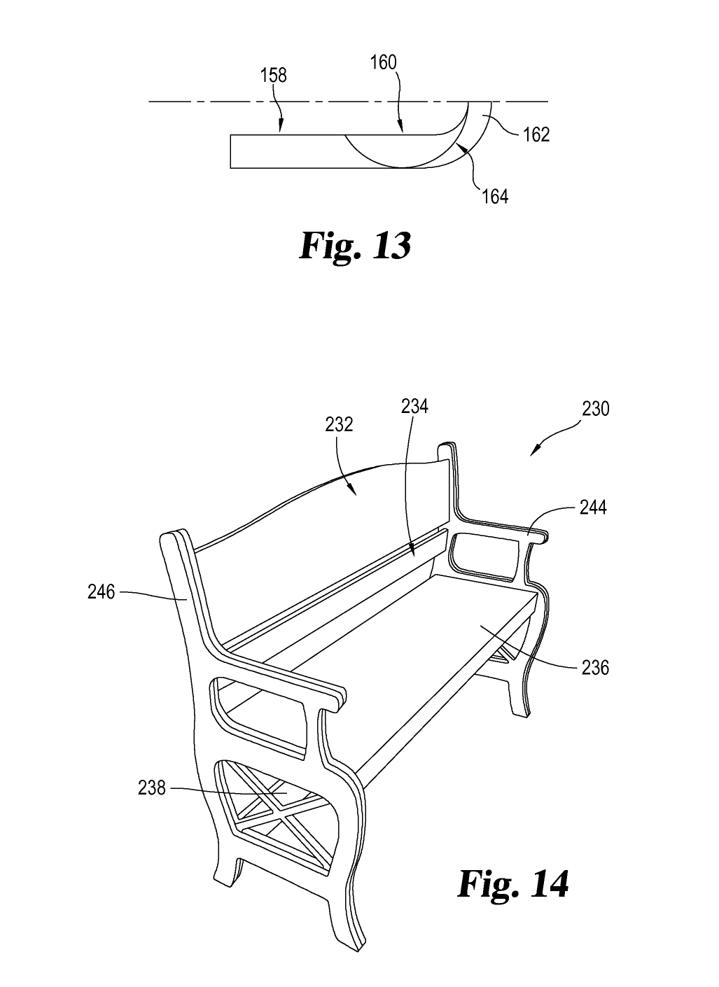

An extended key hole 78 is illustrated in FIGS. 4, 9, and 10. The extended key hole 78 includes a starting end 80 on the back edge 72 of the side panel 36. The extended key hole 78 includes a tab guideway portion 140 that begins at the starting end 80 and extends at an angle relative to the back edge 72 to a tab opening 150. The tab guideway portion 140 has a depth that corresponds to the combined length L1 of the tab 110 and the length L2 of the adjacent groove portion 114. Tab opening 150 has a first diameter 152 that is slightly larger than the diameter D1 of the tab 110 to facilitate and ease turning of tab 110 towards a tab slot portion 154. The tab opening 150 has a second diameter 153 that is smaller than first diameter 152 and/or about the same size as diameter D1 of the tab 110. The tab opening 150 also has a depth that corresponds to the combined length L1 of the tab 110 and the length L2 of the adjacent groove portion 114.

As discussed previously, the extended key hole 78 includes a tab slot portion 154 that is sized to receive the tab 110 and a groove slot portion 156 that is sized to receive the groove portion 114. The tab slot portion 154 is similar to tab slot portion 124. Likewise, the groove slot portion 156 is similar to the groove slot portion 126. The tab slot portion 154 has a width that corresponds to the diameter D1 of tab 110. The tab slot portion 154 also includes a ramp 158, a dowel seat 160, and an end portion 162, similar to the ramp 128, the dowel seat 130, and the end portion 132, respectively, of tab slot portion 124. Similarly, the ramp 158 tapers from the tab opening 150 towards the dowel seat 160 as shown in angle A. During assembly of the cabinet system 30, the tab 110 is pushed along the tab slot portion 154 such that the angle A of the ramp 158 causes a vertical force to be applied to the tab 110. In essence, the tab 110 is squeezed by the ramp 158 as it moves towards the dowel seat 160. As the tab 110 enters or passes into the dowel seat 160, the user will feel a tactile sensation as the tab 110 snaps into the dowel seat 160. The dowel seat 160 has a groove 164 that is curved with a radius that matches the diameter of the tab 110. Another benefit of the dowel seat 160 is that as the tab 110 snaps into the dowel seat 160, stress on the groove portion 114 caused by the taper or angle A of the ramp 158 is reduced. The end portion 162 is sized to receive dust or debris that may be retained in the extended key hole 78 when the extended key hole 78 was formed in the side panels 36. The groove slot portion 156 has a smaller width than the tab slot portion 154 such that the key 44 cannot be pulled out of the extended key hole 78 when the back stretcher panels 40 and side panels 36 are assembled.

To assemble the cabinet system 30, one of the side panels 36 is positioned on a substantially flat surface such as the floor or a table with interior face 62 facing upward. Next, the top and bottom panels 32 and 34, respectively, are assembled with the single side panel 36. It does not matter which of top or bottom panels 32 and 34 is assembled first with the side panel 36. To assemble the top panel 32 with the side panel 36, the extended tabs 110 and groove portions 114 of the keys 44 on the top panel 32 are inserted into the tab openings 120 of the key holes 64 of the side panel 36. Next, the top panel 32 is pushed across the side panel 36 towards the slot 74 such that the tabs 110 ride along the tab slot portions 124 and the groove portions 114 ride along the groove slot portions 126. More specifically, the tabs 110 are pushed along the tab slot portion 124 such that the angle A of the ramp 128 causes a force to be applied to the tab 110. In essence, the tabs 110 are squeezed by the ramps 128 as the tabs 110 move toward the dowel seats 130 but the tabs 110 generally do not enter the dowel seats 130. Thereafter, the ramp 128 applies a force to the tab 110 to maintain the alignment of the top and bottom panels 32 and 34 with the side panels 36.

The bottom panel 34 is assembled with the side panel 36 similarly as the top panel 32. Next the side edge 90 and a portion adjacent the side edge 90 of the back panel 38 is received in one of the slots 74 of the side panels 36. Additionally, top edge 92 and bottom edge 94, respectively, of the back panel 38 are received in the channels 48 and 58 of the top and bottom panels 32 and 34, respectively. Next the other side panel 36 is aligned with the top and bottom panels 32 and 34 such that the extended tabs 110 and groove portions 114 of the keys 44 on the top and bottom panels 32 and 34 enter the tab openings 120 of the key holes 64 on the other side of panel 36.

Next the partially assembled cabinet including the top panel 32, bottom panel 34, side panels 36, and back panel 38 is rotated such that the back panel 38 is facing down and closest to the flat surface, such as the floor (but not resting directly thereon). Then the top and bottom panels 32 and 34 are tapped or pressed into alignment with the side panels 36 as illustrated in FIG. 1. During this alignment step, the tabs 110 enter or pass into the dowel seats 130 and the user will feel a tactile sensation as the tabs 110 snap into the dowel seats 130 and the grooves 134. Another benefit of the dowel seat 130 is that as the tab 110 snaps into the dowel seat 130, stress on the groove portion 114 caused by the taper of ramp 128 is reduced. Then the partially assembled cabinet is rotated such that the back panel 38 is facing up. Each of the back stretcher panels 40 is assembled with the side panels 36 and the respective top or bottom panel 32 and 34 by inserting the tabs 110 and groove portions 114 on the back stretcher panels 40 into the starting end 80 of the tab guideway portion 140 of extended key holes 78 and sliding the tabs 110 along the tab guideway portion 140 to the tab opening 150. As the tab 110 enters the tab opening 150, the tab 110 and groove portion 114 are pushed along the ramp 158 to the dowel seat 160. When the back stretcher panel 40 is fully assembled with the top panel 32, the edge portion 108 of the back stretcher panel 40 will fit into the channel 48 of the top panel 32. Likewise, when the second back stretcher panel 40 is fully assembled with the bottom panel 34, the edge portion 108 of the back stretcher panel 40 will fit into the channel 58 of the bottom panel 34.

The assembly of the back stretcher panels 40 to the top and bottom panels 32 and 34 forms 90° angles between the back stretcher panels 40 and the top panel 32 and the bottom panel 34, respectively. The assembly of the back stretcher panels 40 to the side panels 36 creates 90° angles between the back stretcher panels 40 and the side panels 36. Additionally, the assembly of the keys 44 to the key holes 64 or to the extended key holes 78 enables assembly of the panels without additional hardware, glue, or tools. Another important aspect is that after the top panel 32, bottom panel 34, side panels 36, back panel 38, and back stretcher panels 40 are assembled into a cabinet, there is no visible hardware such as screws, etc., on either the interior or exterior faces of any of these panels thus creating a pleasing visual appearance. Moreover, to assemble the cabinet system 30, no additional hardware or fasteners, such as loose screws, nails, bolts, etc., are required; instead the keys 44 are mounted on the edges of the top panel 32, bottom panel 34, and back stretcher panels 40, enabling one to quickly and easily assemble the cabinet system 30 without having to use tools and separate fasteners.

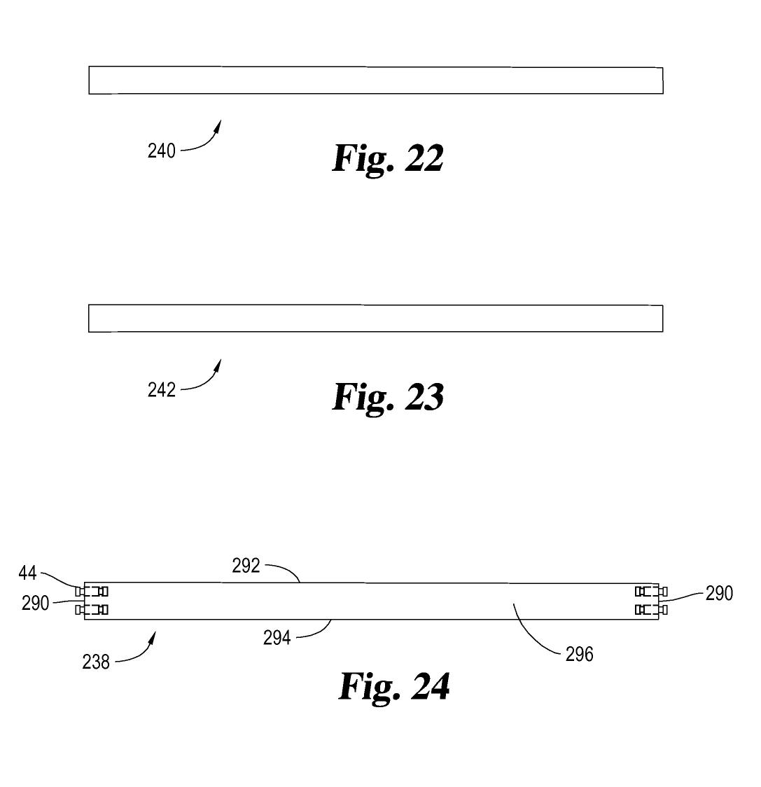

Another embodiment of the present invention includes a bench system 230 as shown in FIGS. 14-24. The bench system 230 is illustrative of a piece of furniture that utilizes two side panels and one or more panels that span between and are connected to the side panels by the interaction of keys and key holes or extended key holes. Other types of furniture include sofas, chairs, tables, bookcases, desks, dressers, chests, and closet systems, to name a few.

The bench system 230 includes a first back panel 232, a second back panel 234, a seat panel 236, a third back panel 238, a first seat support panel 240, a second seat support panel 242, a first side panel 244, a second side panel 246, an optional third side panel 248, and an optional fourth side panel 250. In other embodiments, a different number of back panels, seat support panels, and optional side panels can be included in the bench system 230. For example, an alternative embodiment includes first back panel 232 and seat panel 236, the first side panel 244, and the second side panel 246.

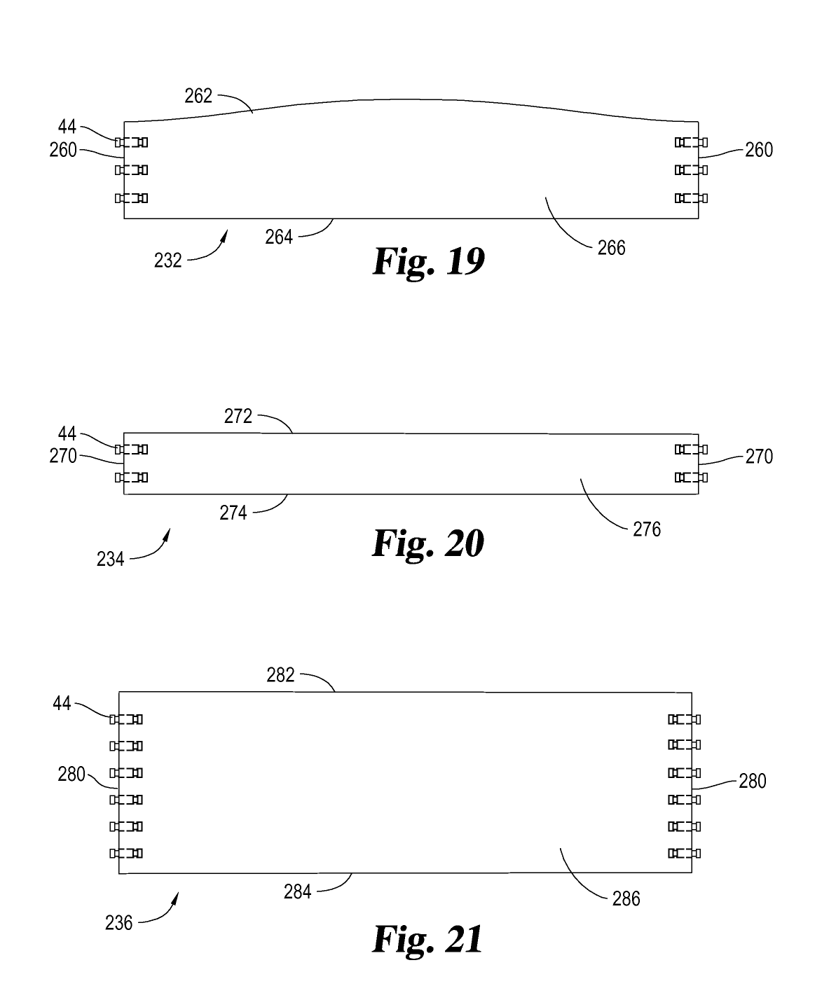

As shown in FIG. 19, the first back panel 232 includes a pair of side edges 260. Along each of the side edges 260 is a plurality of keys or dowels 44. In the illustrated embodiment, there are three keys 44 spaced equidistant from one another along each of the side edges 260; however, other embodiments can include more or less keys 44 or a different spacing between each of the keys 44. The first back panel 232 also includes a front edge 262 opposite a bottom edge 264 that spans the width of the first back panel 232 between the pair of side edges 260. In this embodiment, the front edge 262, the bottom edge 264, an interior surface 266, and an exterior surface opposite to the interior surface 266 are smooth surfaces without holes or fasteners such that when the bench system 230 is assembled, the user does not see any holes and there is an aesthetically pleasing finish to the bench system 230.

The optional second back panel 234 is shown in FIG. 20 and is very similar to the first back panel 232. The second back panel 234 includes a pair of side edges 270. Along each of the sides edges 270 is a plurality of keys or dowels 44. In this embodiment, there are two keys 44 spaced along each of the side edges 270; however, other embodiments can include a different number of keys 44 or a different spacing between each of the keys 44. The second back panel 234 also includes a front edge 272 opposite a bottom edge 274 that spans the width of the second back panel 234 between the pair of side edges 270. In the illustrated embodiment, the front edge 272, the bottom edge 274, an interior surface 276, and an exterior surface opposite to the interior surface 276 are smooth surfaces without holes or fasteners such that when the bench system 230 is assembled, the user sees an aesthetically pleasing finish to the bench system 230.

As shown in FIG. 21, the seat panel 236 includes a pair of side edges 280. Along each of the side edges 280 is a plurality of keys or dowels 44. In the illustrated embodiment, there are six keys 44 spaced equidistant from one another along each of the side edges 280; however, other embodiments can include more or less keys 44 or a different spacing between each of the keys 44. The seat panel 236 also includes a front edge 282 opposite a bottom edge 284 that spans the width of the seat panel 236 between the pair of side edges 280. In this embodiment, the front edge 282, the bottom edge 284, an interior surface 286, and an exterior surface opposite to the interior surface 286 are smooth surfaces without holes or fasteners such that when the bench system 230 is assembled, the user does not see any holes and there is an aesthetically pleasing finish to the bench system 230.

The optional third back panel 238 is shown in FIG. 24 and is very similar to the first back panel 232. The third back panel 238 includes a pair of side edges 290. Along each of the sides edges 290 is a pair of keys or dowels 44. Other embodiments can include a different number of keys 44 or a different spacing between each of the keys 44. The third back panel 238 also includes a front edge 292 opposite a bottom edge 294 that spans the width of the third back panel 238 between the pair of side edges 290. In the illustrated embodiment, the front edge 292, the bottom edge 294, an interior surface 296, and an exterior surface opposite to the interior surface 296 are smooth surfaces without holes or fasteners such that when the bench system 230 is assembled, the user does not see any holes and there is an aesthetically pleasing finish to the bench system 230.

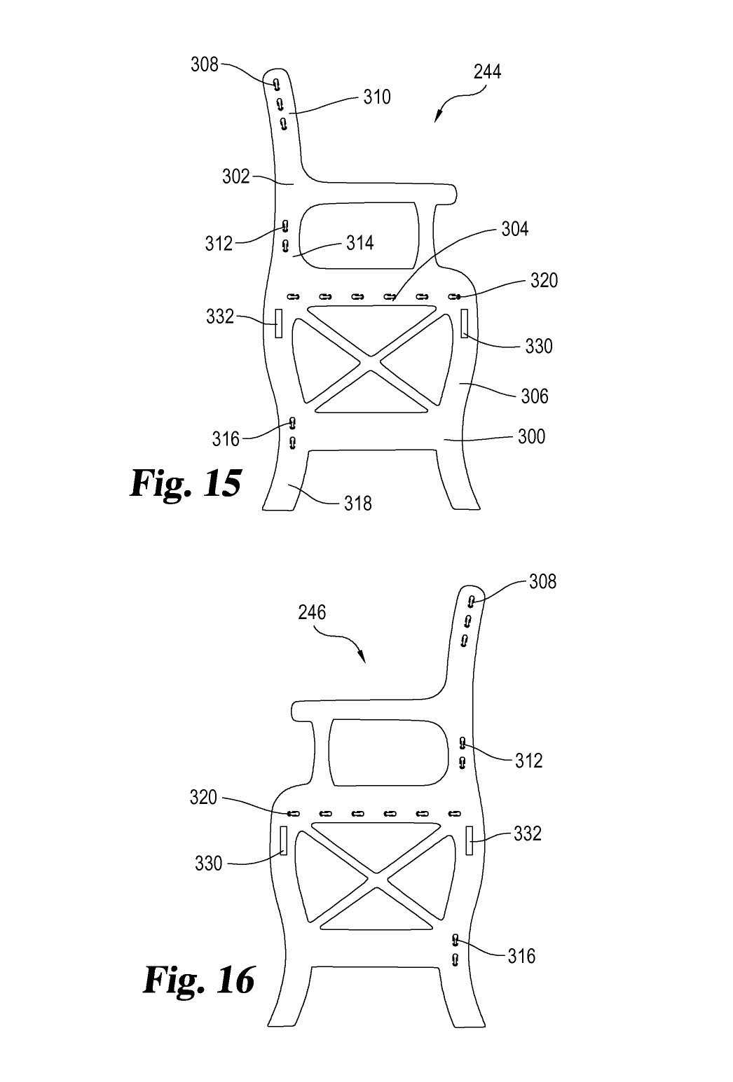

The first side panel 244 and the second side panel 246 are illustrated in FIGS. 15 and 16, respectively. The second side panel 246 is identical to but a mirror image of the first side panel 244 wherein the second side panel 246 includes all of the features of the first side panel 244. Therefore, only the first side panel 244 will be discussed.

The first side panel 244 includes an interior face 300 opposite an exterior face, a back portion 302, a seat portion 304, and a front portion 306. The back portion 302 has a plurality of key holes 308 that are positioned along an upper portion 310 of the back portion 302. The plurality of key holes 308 are located on the back portion 302 to enable attachment of the keys 44 and the first back panel 232 to the first side panel 244. In the illustrated embodiment, there are three key holes 308 and three keys 44; however, other embodiments may include more or less key holes or keys so long as there are the same number of each. The back portion 302 also has two key holes 312 that are positioned along a mid-portion 314 of the back portion 302. The key holes 312 enable attachment of the keys 44 of the second back panel 234 to the first side panel 244. In the illustrated embodiment, there are two key holes 312 and two keys 44; however, other embodiments may include more or less key holes and keys so long as there are the same number of each. The back portion 302 also has two key holes 316 that are located on a lower portion 318 of the back portion 302. The key holes 316 enable attachment of the keys 44 of the third back panel 238 to the first side panel 244. In the illustrated embodiment, there are two key holes 316 and two keys 44; however, other embodiments may include more or less key holes and keys so long as there are the same number of each. The seat portion 304 has a plurality of key holes 320 to enable attachment of the keys 44 of the seat panel 236 to the first side panel 244. In the illustrated embodiment, there are six key holes 320 and six keys 44; however, other embodiments may include more or less key holes and keys so long as there are the same number of each. The key holes 308, 312, 316, 320 are identical to each other except for the location on the first side panel 244. Moreover, the key holes 308, 312, 316, 320 are identical to key holes 64.

In the illustrated embodiment, the first side panel 244 includes a first recess 330 and a second recess 332 sized to receive an end portion of first seat support panel 240 and an end portion of second seat support panel 242, respectively. Other embodiments may not include the first and second recesses 330 and 332 and the first and second seat support panels 240 and 242. The first and second recesses 330 and 332 are positioned beneath the seat portion 304 and the plurality of key holes 320 when the first side panel 244 is in an upright position as depicted in FIG. 15.

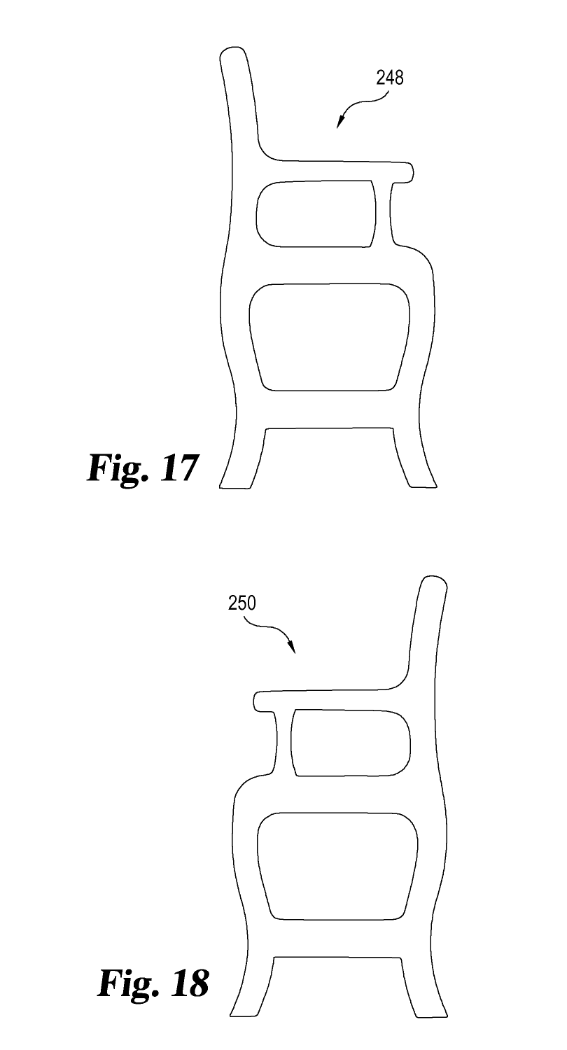

The third side panel 248 and the fourth side panel 250 are illustrated in FIGS. 17 and 18, respectively. The third side panel 248 and the fourth side panel 250 are the same shape and size as the first side panel 244 and the second side panel 246, respectively. In one embodiment, the third side panel 248 is attached to the first side panel 244 via glue or other adhesive and similarly the fourth side panel 250 is attached to the second side panel 246 via glue or adhesive. In another embodiment, the third side panel 248 and the fourth side panel 250 each include a plurality of keys and the exterior faces of the first side panel 244 and the second side panel 246 each include a corresponding number of key holes to receive and retain the keys to attach the third side panel 248 and the fourth side panel 250 to the first side panel 244 and the second side panel 246, respectively. In other embodiments, the third side panel 248 and the fourth side panel 250 are not included.

In one embodiment, to assemble the bench system 230, either the first side panel 244 or the second side panel 246 is positioned on a substantially flat surface such as the floor with the interior surface 266 facing upward. Next, the first back panel 232, the second back panel 234, the seat panel 236, and the third back panel 238 are each assembled with the first side panel 244. The order of assembly for the first back panel 232, the second back panel 234, the seat panel 236, and the third back panel 238 can vary in other embodiments.

To assemble the first back panel 232 with the first side panel 244, the extended tabs 110 and groove portions 114 of keys 44 are inserted into the tab openings of the key holes 308. Next, the first back panel 232 is pushed across the first side panel 244 towards the slot such that the tabs 110 ride along the tab slot portions and the groove portions 114 ride along the groove slot portions. The interaction and engagement between the keys 44 and key holes 308 is the same as the interaction between the keys 44 and key holes 64. To assemble the second back panel 234 to the first side panel 244, the extended tabs 110 and groove portions 114 of keys 44 are inserted into the tab openings of the key holes 312 and the second back panel 234 is pushed across the first side panel 244 towards the slot such that the tabs 110 ride along the tab slot portions and the groove portions 114 ride along the groove slot portions. The interaction and engagement between the keys 44 and key holes 312 is the same as or similar to the interaction between the keys 44 and key holes 64. Next the seat panel 236 and the third back panel 238 are assembled with the first side panel 244 similarly as the first back panel 232 was assembled with the first side panel 244.

In one embodiment, the end portion of first seat support panel 240 and the end portion of second seat support panel 242 are inserted into the first and the second recesses 330 and 332, respectively, to assemble the first and second seat support panels 240 and 242 with the first side panel 244. The second side panel 246 is assembled by inserting the extended tabs 110 and groove portions 114 of keys 44 of the first back panel 232, the second back panel 234, the seat panel 236, and the third back panel 238 into the tab openings of key holes 308, 312, 316, and 320, respectively. The opposite end portion of first seat support panel 240 and the opposite end portion of second seat support panel 242 are inserted into the first and the second recesses 330 and 332, respectively, to assemble the first and second seat support panels 240 and 242 with the second side panel 246. In other embodiments, the first seat support panel 240 and second seat support panel 242 are not included.

Lastly, the third and the fourth side panels 248 and 250 are assembled with the first and the second side panels 244 and 246. Other embodiments may not include the third and the fourth side panels 248 and 250.

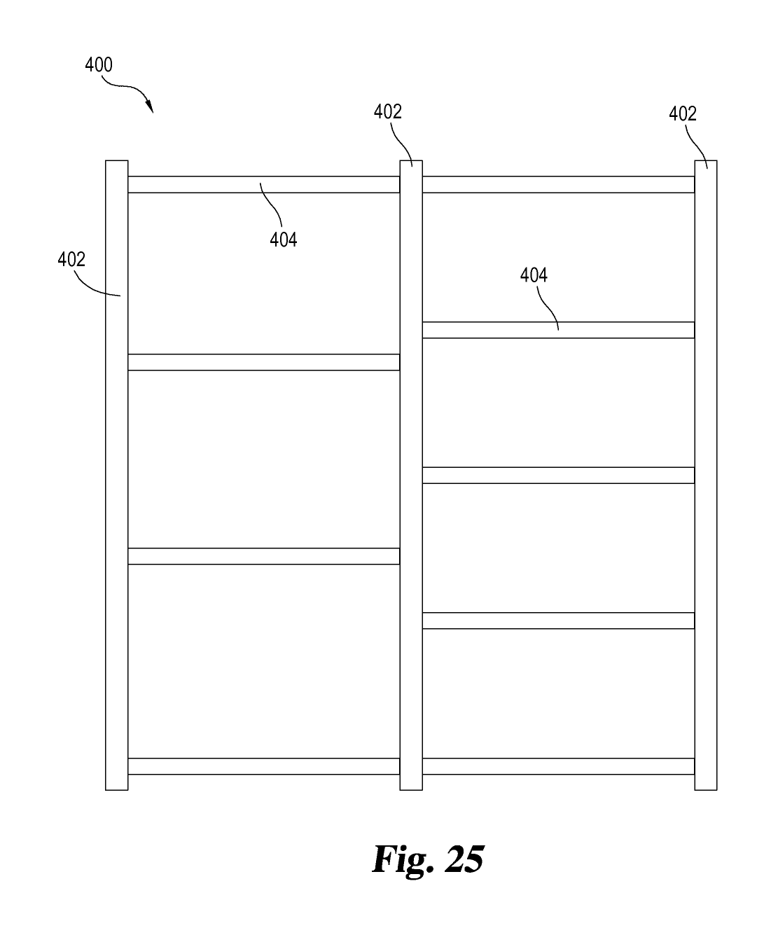

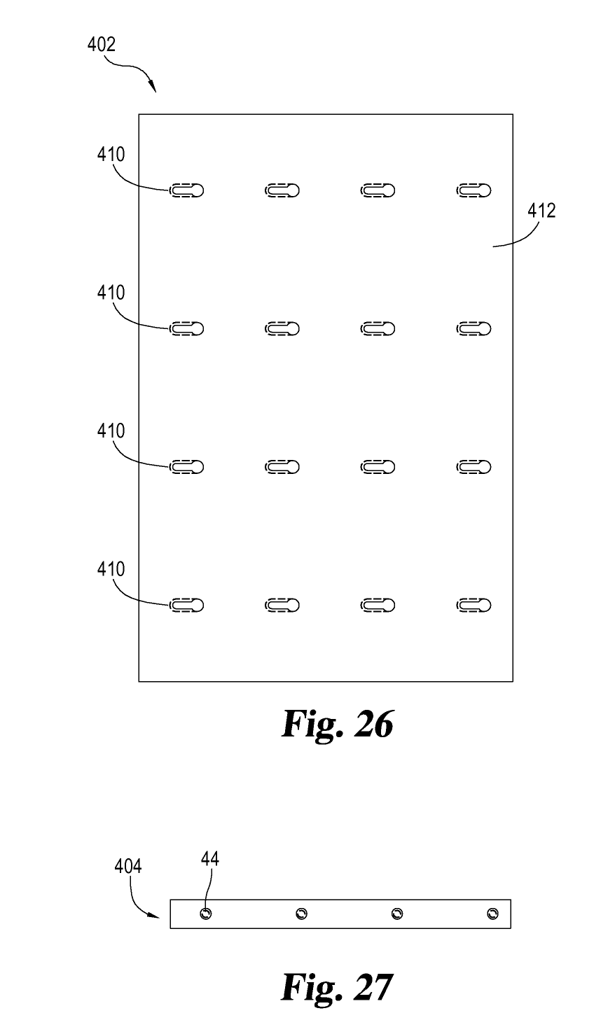

In yet another embodiment, a closet or shelving system 400 is illustrated in FIGS. 25, 26, and 27. The illustrated closet system 400 includes three side panels 402 and nine horizontal panels 404. Other configurations of the closet system 400 can include more or less horizontal panels 404 and/or side panels 402. Moreover, the length and width of horizontal panels 404 may vary between pairs of side panels 402. For example, one embodiment may include a first plurality of horizontal panels 404 that are all a first length and span between a first side panel 402 and a second side panel 402. This embodiment can also include a second plurality of horizontal panels 404 that are all a second length and span between the second side panel 402 and a third side panel 402. The first length and the second length of the horizontal panels 404 may be different. Moreover, there may be a different number of the first plurality of horizontal panels 404 as compared to the second plurality of horizontal panels 404. Other embodiments may include drawers connected with the side panels 402, doors attached to the horizontal panels 404, rods or bars that span between the side panels, and other closet accessories.

The side panel 402 includes a plurality of key holes 410 along an interior face 412 and an exterior face (not illustrated) of the side panel 402. The plurality of key holes 410 are the same or similar as the key holes 64. In the illustrated embodiment, four rows of key holes 410 are positioned on the interior face 412 although other embodiments can contain a different number of key holes 410. The exterior face can contain a different number of rows of key holes 410 or none at all. The key holes 410 on the interior face 412 and the exterior face enable attachment of at least one horizontal panel 404 to each face such that the horizontal panels 404 are attached to both the interior and exterior faces of the single side panel 402.

The horizontal panels 404 include a corresponding number of keys 44 along each of their side edges to engage the key holes 410 of the side panels 402. In this embodiment, the horizontal panels 404 include four keys 44 positioned to engage the key holes 410 when the horizontal panel 404 is attached to the side panel 402. Other configurations of keys 44 and key holes 410 are possible in other embodiments of the closet system.

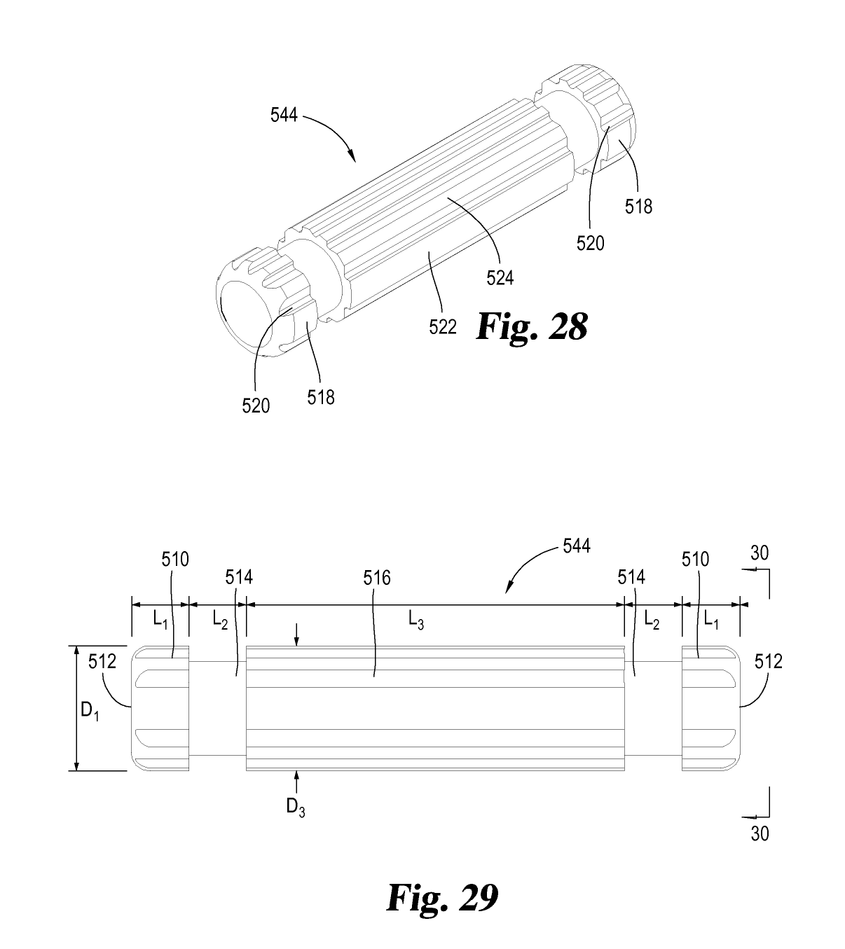

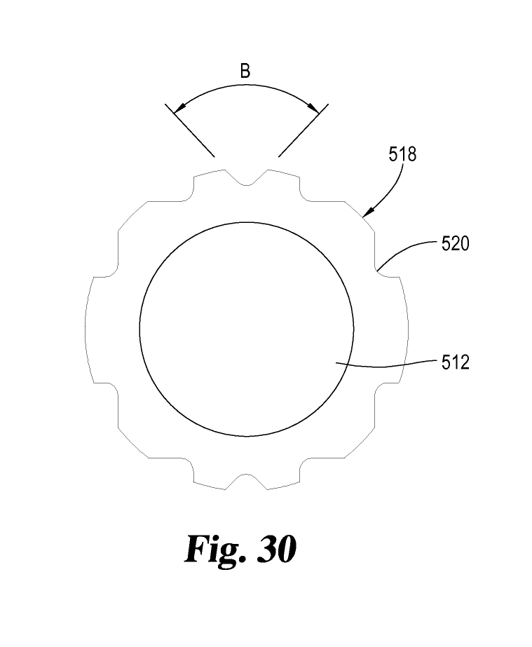

Another embodiment of a key 544 is illustrated in FIGS. 28, 29, and 30. Key 544 is similar to key 44 but includes other unique features and dimensions. Key 544 may be used in any location that key 44 is described throughout the present application. Key 544 includes a tab 510 at each end 512, a groove portion 514 next to each of the tabs 510, and an extender 516 that spans between the groove portions 514. Each of the tab 510, groove portion 514, and the extender 516 has a circular cross-sectional shape. Tab 510 has a diameter D1 and a length L1, groove portion 514 has a diameter D2 and a length L2, and extender 516 has a diameter D3 and a length L3. In other embodiments, the tab 510, groove portion 514, and the extender 516 have an alternative cross-sectional shape such as triangular, square, polygonal, or oval. In the illustrated embodiment, the diameters D1 and D3 are larger than the diameter D2 of groove portion 514. In one form the diameter D1 of the tab 510 is between 20 to 50 percent larger than the diameter D3 of the extender 516. One embodiment of the tab 510 and the extender 516 have diameters D1 and D3 of about 0.40 inches and the groove portion 514 has a diameter D2 of about 0.30 inches. In the illustrated embodiment, the length L1 of the tab 510 is about the same as the length L2 of the groove portion 514. For example, the lengths L1 and L2 range from about 0.10 inches to 0.5 inches or more. In other embodiments the length L1 is different than the length L2 such that one of the tab 510 or the groove portion 514 is longer than the other. In the illustrated embodiment, the extender 516 has a longer length L3 than the length L1 or L2 of the either the tab 510 or the groove portion 514.

The tab 510 has a cylindrical outer surface that is formed by a plurality of smooth portions 518 that alternate with a plurality of depressions 520. In the illustrated embodiment, there are 10 of the smooth portions 518 and 10 of the depressions 520 however other embodiments can include more or less of either the smooth portions 518 or the depressions 520. The width of each of the smooth portions 518 is the same or the width can vary from one another. The depressions 520 can form a concave shape, a notch, a semi-circular shape, or a polygonal shape between the smooth portions 518. For example, depressions 520 have a radius that ranges between about 0.010 inches to about 0.90 inches. As another example, depressions 520 form an angle B that can be acute, obtuse, or a right angle. For example, angle B can range from 20 degrees to about 80 degrees. In the illustrated embodiment, angle B is about 90 degrees. Alternatively, each of depressions 520 has a unique shape or orientation relative to one another. The groove portion 514 has a substantially smooth outer surface however other embodiments can include indentations or depressions.

The extender 516 is similar to the tab 510 and includes a cylindrical outer surface that is formed by a plurality of smooth portions 522 that alternate with a plurality of depressions 524. In the illustrated embodiment, the smooth portions 522 are the same shape and size as the smooth portions 518 however in other embodiments the smooth portions 522 can have a different shape or size than smooth portions 518. In the illustrated embodiment, the depressions 524 are the same shape and size as the depressions 520 however in other embodiments the depressions 524 can have a different shape or size than the depressions 520. Moreover, the depressions 520 and 524 retain glue or adhesive with the tab 510 and extender 516 when key 544 is assembled with the furniture element.

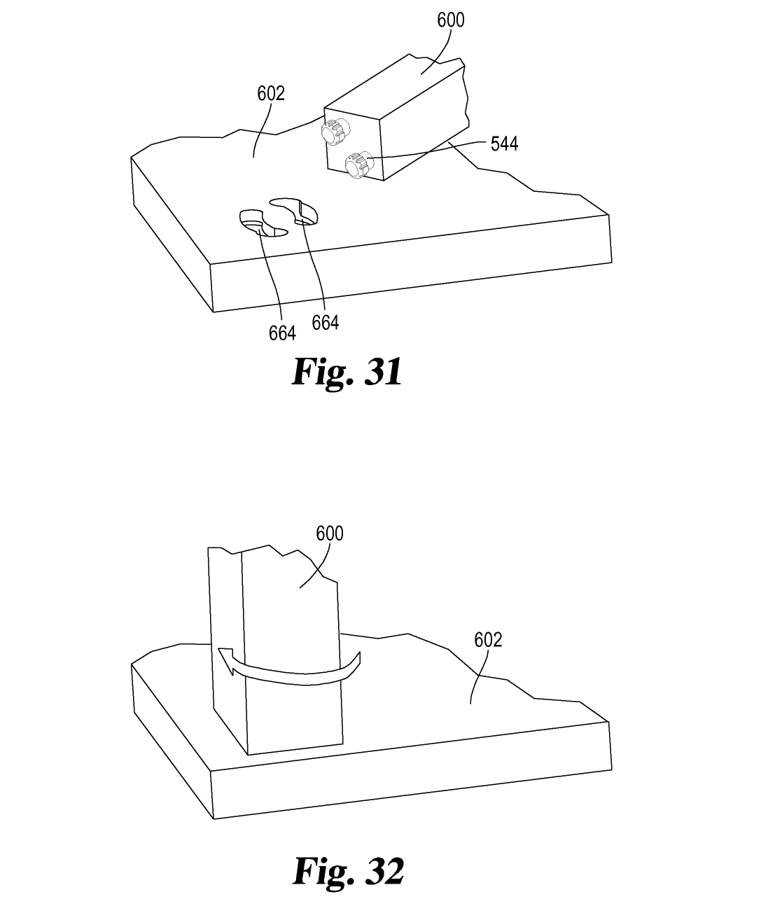

In FIGS. 31 and 32 a further example of a joint according to the present disclosure is illustrated. In the illustrated embodiment a table leg 600 is to be assembled to a table top 602, however other furniture elements can include similar details as described next. As such any two furniture elements can be assembled wherein a first furniture element includes a key and a second furniture element includes a key hole. The table leg 600 has two keys 544 at an end of the table leg to be attached to the table top 602. Two key holes 664 are arranged at a short distance from each other on a lower side of the table top 602. The key holes 664 are arranged in the area of a corner of the table top 602. The key holes 664 have a curved form and in a corresponding way as described above include all of the features of key hole 64. For example key holes 664 each have a tab opening, a tab slot portion, and a groove portion as described above for key hole 64. Furthermore, the tab slot portion of the key holes 664 has a ramp, a dowel seat, and an end portion similar to key hole 64. The key holes 664 of the table top 602 are to receive the two keys 544. The table leg 600 is to be assembled to the table top 602 in that the keys 544 are inserted into the tab openings of the key holes 664, where after the table leg 600 is turned in such a way that the keys 544 will slide inside the key holes 664 until the keys 544 reach the end of the ramp of the key holes 664 and then move into the dowel seat of the key holes 664 of the table top 602. The movement of the table leg 600 during assembly is indicated by the arrow in FIG. 32.

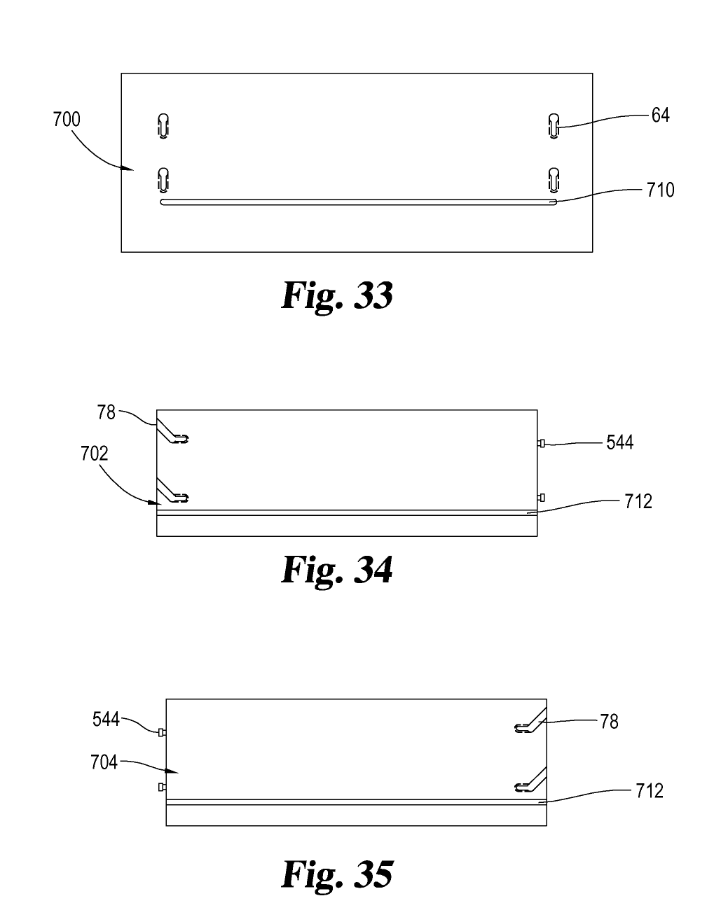

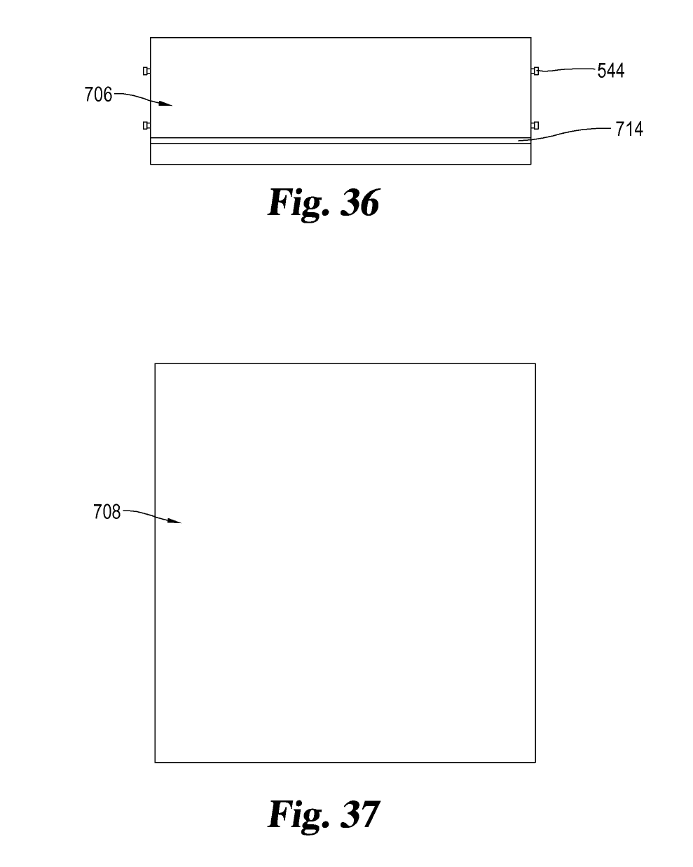

In FIGS. 33, 34, 35, 36, and 37 is another example of furniture elements that are assembled to form an article of furniture. As can be appreciated any two furniture elements can be assembled wherein a first furniture element includes a key and a second furniture element includes a key hole. In this embodiment, a drawer or cabinet includes a front element 700, a first side element 702, a second side element 704, a back element 706, and a bottom element 708. The front element 700 includes four key holes 64 as described previously and a slot 710 for receipt of an edge of the bottom element 708. The first side element 702 and the second side element 704 each include two extended key holes 78, two keys 544, and a groove 712 sized for receipt of an edge of the bottom element 708. The keys 544 are arranged for insertion into the key holes 64 of the front element 700 for assembly of the first side element 702 and the second side element 704 with the front element 700. The back element 706 includes four keys 544 and a groove 714 sized for receipt of an edge of the bottom element 708.

Any of the above keys 44 and 544 are attached to any of the furniture elements in different ways, such as by glue, adhesive, welding, other attachment means, or by forming monolithically with the furniture element. The keys 44 and 544 can be made of plastic, polymer, acrylic, hardwood, softwood, or any other materials that are compatible with the furniture elements. Also beneficially it has been found cost effective to use keys 44 and 544 that are symmetrical since it would not matter which end of the key extends from the furniture element or is inserted into the furniture element. Moreover, a standard piece of equipment such as a bore and dowel insertion machine having a vibratory bowl or other equipment enables either end of the key to be inserted into the furniture element. Any of the above key holes are formed in any of the furniture elements in different ways such as point-to-point machine or a computer numerically controlled (CNC) router. The key holes can be formed in furniture elements made of hardwood, softwood, plastic, particle board, acrylic, polymer, stone, granite, and quartz, or any combination of these materials, however other materials can be used. Moreover, the keys and the key holes may be larger or smaller than illustrated.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. An article of furniture comprising:
a first furniture element including a key, the key having a groove portion adjacent a tab; and
a second furniture element having a key hole, the key hole defining a groove slot portion sized for receipt of the groove portion of the key, the key hole also defining a tab slot portion sized for receipt of the tab, the tab slot portion configured to press against the tab of the key as the tab slides along the tab slot portion to connect the first furniture element to the second furniture element.

2. The article of furniture of claim 1, wherein the tab slot portion includes a ramp that is configured to press against the tab.

3. The article of furniture of claim 2, wherein the tab slot portion includes a dowel seat, and movement of the tab into the dowel seat reduces the pressure on the tab from the ramp.

4. The article of furniture of claim 3, wherein the dowel seat includes a groove sized to receive the tab.

5. The article of furniture of claim 1, wherein the tab slot portion includes an end portion.

6. The article of furniture of claim 1, wherein a width of the groove slot portion is less than a width of the tab slot portion to retain the key in the key hole.

7. The article of furniture of claim 1, wherein a width of the groove portion of the key is less than a width of the tab of the key.

8. The article of furniture of claim 1, wherein the key includes a second tab adjacent a second groove portion and an extender that spans between the groove portion and the second groove portion.

9. A furniture joint comprising:
a key having a groove portion adjacent a tab, the key mounted in a first furniture element wherein the groove portion and the tab extend from the first furniture element; and
a key hole formed in a second furniture element, the key hole defining a groove slot portion sized to receive the groove portion of the tab, the key hole defining a tab slot portion sized to receive the tab, the tab slot portion having a ramp that presses against the tab of the key when the tab is inserted into the tab slot portion.

10. The furniture joint of claim 9, wherein the key hole includes a tab opening sized to receive the tab.

11. The furniture joint of claim 10, wherein the tab opening has a length that spans from a first diameter that is larger than a diameter of the tab to a second diameter that is substantially the same size as the diameter of the tab.

12. The furniture joint of claim 9, wherein the ramp forms an angle between 0.5 degrees and 30 degrees.

13. The furniture joint of claim 9, wherein a width of the groove slot portion is less than a width of the tab slot portion to retain the key in the key hole.

14. The furniture joint of claim 9, wherein the tab slot portion includes a dowel seat, and movement of the tab into the dowel seat reduces the pressure on the tab from the ramp.

15. The furniture joint of claim 14, wherein the tab is circular, and the dowel seat has a curved groove with a radius that is substantially the same as a radius of the tab.

16. An article of furniture, comprising:
a first furniture element having a key, the key including a groove portion adjacent a tab wherein the groove portion and the tab extend from the first furniture element; and
a second furniture element having a key hole, the key hole defining a groove slot portion configured to receive the groove portion of the key, the key hole defining a tab slot portion configured to press against the tab of the key to retain the first furniture element with the second furniture element.

17. The article of furniture of claim 16, wherein the key hole includes a tab guideway portion that spans from an edge of the second furniture element to the tab slot portion, the tab guideway portion sized to receive the tab and the groove portion.

18. The article of furniture of claim 16, wherein the tab has a longitudinal axis and the tab slot portion includes a ramp that applies a force in a longitudinal direction against the tab.

19. The article of furniture of claim 18, wherein the tab slot portion includes a dowel seat configured to retain the tab.

20. The article of furniture of claim 16, wherein the key is symmetrical.
